(19) United States
(12) Patent Application Publication
(10) Pub. No.: US 2020/0024951 A1
(43) Pub. Date: Jan. 23, 2020

(54) COMPONENT FOR A TURBINE ENGINE WITH A COOLING HOLE

(71) Applicant: GENERAL ELECTRIC COMPANY, Schenectady, NY (US)

(72) Inventors: William Charles Herman, Cincinnati, OH (US); Jacob Romeo Rendon, Cedar Park, TX (US); Duane Allan Busch, Loveland, OH (US); Ryan Christopher Jones, Cincinnati, OH (US); Paul Christopher Schilling, Waynesville, OH (US); Zachary Daniel Webster, Mason, OH (US); Tingfan Pang, West Chester, OH (US); Gregory Terrence Garay, West Chester, OH (US); Steven Robert Brassfield, Cincinnati, OH (US)

(21) Appl. No.: 16/037,662

(22) Filed: Jul. 17, 2018

(51) Int. Cl. F01D 5/08

(52) U.S. Cl. CPC F01D 5/087; F05D 2220/321; F05D 2240/301; F05D 2230/21; F05D 2230/90; F05D 2230/10; F05D 2260/202

(57) ABSTRACT

An apparatus and method relating to a cooling hole of a component of a turbine engine. The cooling hole can extend from an inlet to an outlet to define a passage. The cooling hole can include a laid back section where a coating can be applied. The method can include forming the cooling hole in the component and applying the coating to the component to maintain a specific geometry.

### BACKGROUND OF THE INVENTION

Turbine engines, and particularly gas or combustion turbine engines, are rotary engines that extract energy from a flow of combusted gases passing through the engine onto a multitude of rotating turbine blades.

Engine efficiency increases with temperature of combustion gases. However, the combustion gases heat the various components along their flow path, which in turn requires cooling thereof to achieve a long engine lifetime. Typically, the hot gas path components are cooled by bleeding air from the compressor. This cooling process reduces engine efficiency, as the bled air is not used in the combustion process.

Turbine engine cooling art is mature and is applied to various aspects of cooling circuits and features in the various hot gas path components. For example, the combustor includes radially outer and inner liners, which require cooling during operation. Turbine nozzles include hollow vanes supported between outer and inner bands, which also require cooling. Turbine rotor blades are hollow and typically include cooling circuits therein, with the blades being surrounded by turbine shrouds, which also require cooling. The hot combustion gases are discharged through an exhaust which may also be lined, and suitably cooled.

In all of these exemplary turbine engine components, thin metal walls of high strength superalloy metals are typically used for enhanced durability while minimizing the need for cooling thereof. Various cooling circuits and features are tailored for these individual components in their corresponding environments in the engine. These components typically include common rows of film cooling holes.

A typical film cooling hole is a cylindrical bore for discharging a film of cooling air along the external surface of the wall to provide thermal insulation against the flow from hot combustion gases during operation. A coating, for example a thermal barrier coating, can be applied to portions of the cooling hole to prevent damage. The coating can contribute to an undesirable stream away from the heated wall rather than along the heated wall, which can lead to flow separation and a loss of the film cooling effectiveness. The geometrical relationship between the coating and the cooling hole can affect engine efficiency and airfoil cooling.

### BRIEF DESCRIPTION OF THE INVENTION

In one aspect the disclosure relates to a component for a turbine engine which generates a hot gas fluid flow, and provides a cooling fluid flow, comprising a wall separating the hot gas fluid flow from the cooling fluid flow and having a heated surface along which the hot gas fluid flow flows and a cooled surface facing the cooling fluid flow. The engine component includes at least one cooling hole comprising at least one inlet at the cooled surface and at least one outlet at the heated surface, at least one connecting passage extending between the at least one inlet and the at least one outlet to define a passage centerline, at least one pocket opening onto the heated surface, opening into the connecting passage below the heated surface, and having a sidewall extending laterally to and spaced from the passage centerline, and a coating provided on the heated surface, surrounding the at least one outlet, and filling a portion of the pocket to define a filled portion which defines at least a portion of the connecting passage.

In yet another aspect, the disclosure relates to a method for forming a cooling hole with a predetermined outlet dimension in a wall of an engine component for a turbine engine, with the wall defining first and second surfaces separating a hot gas fluid flow from a cooling fluid flow, the method comprising forming a cooling hole in the wall such that the cooling hole has an inlet on the first surface with an inlet dimension, an outlet on the second surface, a connecting passage connecting the inlet and the outlet, forming a pocket in the wall on a downstream side of the outlet and fluidly coupled to the connecting passage to define an opening with a dimension larger than the predetermined outlet dimension, applying a coating to the engine component such that the coating fills in a portion of the pocket while leaving the outlet with the predetermined outlet dimension.

### BRIEF DESCRIPTION OF THE DRAWINGS

In the drawings:

FIG. 1 is a schematic cross-sectional diagram of a turbine engine for an aircraft.

FIG. 2 is an isometric view of an airfoil for the turbine engine of FIG. 1 in the form of a blade and having a platform with cooling holes.

FIG. 3 is an enlarged view of a portion of FIG. 1 of the platform with the cooling holes.

FIG. 4 is a cross-sectional view of one of the cooling holes from FIG. 3 according to an aspect of the disclosure herein.

FIG. 5 is a top view of the cooling hole from FIG. 4 according to an aspect of the disclosure herein.

FIG. 6 is a cross-sectional view of a straight drilled cooling hole located in a platform like the platform of FIG. 2.

FIG. 7 is a cross-sectional view of the cooling hole from FIG. 4 after a coating has been applied according to an aspect of the disclosure herein.

FIG. 8 is a cross-sectional view a cooling hole according to another aspect of the disclosure herein.

FIG. 9 is a top down view of the cooling hole from FIG. 8 according to an aspect of the disclosure herein.

FIG. 10 is a cross-sectional view of the cooling hole from FIG. 8 after a coating has been applied according to an aspect of the disclosure herein.

FIG. 11 is a cross-sectional view taken along line XI-XI of FIG. 10.

FIG. 12 is a perspective view of an exemplary blade platform with a number of cooling holes.

FIG. 13 is a perspective view of an exemplary blade platform with a larger number of cooling holes than the exemplary blade platform of FIG. 6.

### DESCRIPTION OF EMBODIMENTS OF THE INVENTION

Aspects of the disclosure described herein are directed to the formation of a hole such as a cooling hole in an engine component such as an airfoil. For purposes of illustration, the aspects of the disclosure discussed herein will be described with respect to the platform portion of a blade. It will be understood, however, that the disclosure as discussed herein is not so limited and may have general applicability within an engine, including compressors, as well as in non-aircraft applications, such as other mobile applications and non-mobile industrial, commercial, and residential applications.

As used herein, the term “forward” or “upstream” refers to moving in a direction toward the engine inlet, or a component being relatively closer to the engine inlet as compared to another component. The term “aft” or “downstream” used in conjunction with “forward” or “upstream” refers to a direction toward the rear or outlet of the engine relative to the engine centerline. Additionally, as used herein, the terms “radial” or “radially” refer to a dimension extending between a center longitudinal axis of the engine and an outer engine circumference. Furthermore, as used herein, the term “set” or a “set” of elements can be any number of elements, including only one.

All directional references (e.g., radial, axial, proximal, distal, upper, lower, upward, downward, left, right, lateral, front, back, top, bottom, above, below, vertical, horizontal, clockwise, counterclockwise, upstream, downstream, aft, etc.) are only used for identification purposes to aid the reader's understanding of the present disclosure, and do not create limitations, particularly as to the position, orientation, or use of the disclosure. Connection references (e.g., attached, coupled, connected, and joined) are to be construed broadly and can include intermediate members between a collection of elements and relative movement between elements unless otherwise indicated. As such, connection references do not necessarily infer that two elements are directly connected and in fixed relation to one another. Furthermore it should be understood that the term cross section or cross-sectional as used herein is referring to a section taken orthogonal to the centerline and to the general coolant flow direction in the hole. The exemplary drawings are for purposes of illustration only and the dimensions, positions, order and relative sizes reflected in the drawings attached hereto can vary.

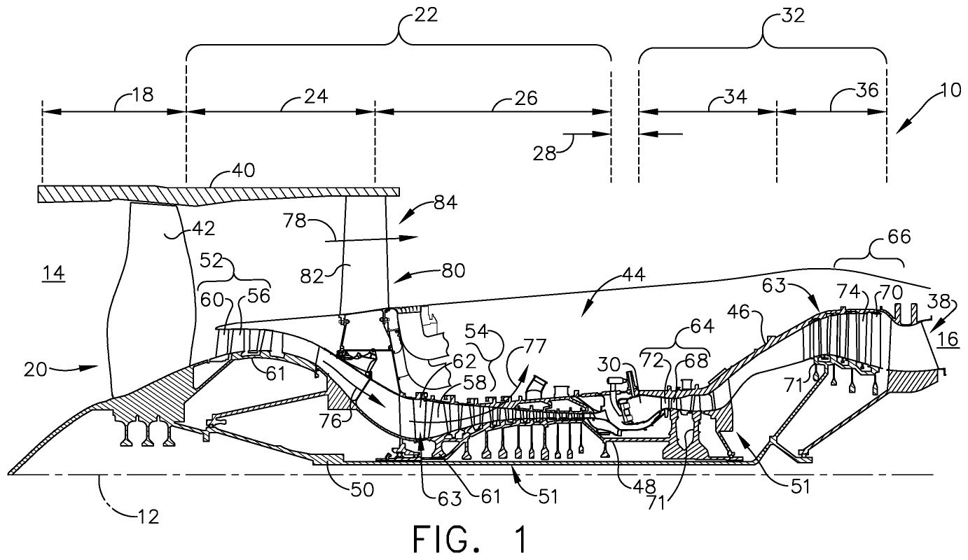

Referring to FIG. 1, an engine 10 has a generally longitudinally extending axis or centerline 12 extending forward 14 to aft 16. The engine 10 includes, in downstream serial flow relationship, a fan section 18 including a fan 20, a compressor section 22 including a booster or low pressure (LP) compressor 24 and a high pressure (HP) compressor 26, a combustion section 28 including a combustor 30, a turbine section 32 including a HP turbine 34, and a LP turbine 36, and an exhaust section 38.

The fan section 18 includes a fan casing 40 surrounding the fan 20. The fan 20 includes a plurality of fan blades 42 disposed radially about the centerline 12. The HP compressor 26, the combustor 30, and the HP turbine 34 form a core 44 of the engine 10, which generates combustion gases. The core 44 is surrounded by core casing 46, which can be coupled with the fan casing 40.

A HP shaft or spool 48 disposed coaxially about the centerline 12 of the engine 10 drivingly connects the HP turbine 34 to the HP compressor 26. A LP shaft or spool 50, which is disposed coaxially about the centerline 12 of the engine 10 within the larger diameter annular HP spool 48, drivingly connects the LP turbine 36 to the LP compressor 24 and fan 20. The spools 48, 50 are rotatable about the engine centerline and couple to a plurality of rotatable elements, which can collectively define a rotor 51.

The LP compressor 24 and the HP compressor 26 respectively include a plurality of compressor stages 52, 54, in which a set of compressor blades 56, 58 rotate relative to a corresponding set of static compressor vanes 60, 62 (also called a nozzle) to compress or pressurize the stream of fluid passing through the stage. In a single compressor stage 52, 54, multiple compressor blades 56, 58 can be provided in a ring and can extend radially outwardly relative to the centerline 12, from a blade platform to a blade tip, while the corresponding static compressor vanes 60, 62 are positioned upstream of and adjacent to the rotating blades 56, 58. It is noted that the number of blades, vanes, and compressor stages shown in FIG. 1 were selected for illustrative purposes only, and that other numbers are possible.

The blades 56, 58 for a stage of the compressor mount to a disk 61, which mounts to the corresponding one of the HP and LP spools 48, 50, with each stage having its own disk 61. The vanes 60, 62 for a stage of the compressor mount to the core casing 46 in a circumferential arrangement.

The HP turbine 34 and the LP turbine 36 respectively include a plurality of turbine stages 64, 66, in which a set of turbine blades 68, 70 are rotated relative to a corresponding set of static turbine vanes 72, 74 (also called a nozzle) to extract energy from the stream of fluid passing through the stage. In a single turbine stage 64, 66, multiple turbine blades 68, 70 can be provided in a ring and can extend radially outwardly relative to the centerline 12, from a blade platform to a blade tip, while the corresponding static turbine vanes 72, 74 are positioned upstream of and adjacent to the rotating blades 68, 70. It is noted that the number of blades, vanes, and turbine stages shown in FIG. 1 were selected for illustrative purposes only, and that other numbers are possible.

The blades 68, 70 for a stage of the turbine can mount to a disk 71, which is mounts to the corresponding one of the HP and LP spools 48, 50, with each stage having a dedicated disk 71. The vanes 72, 74 for a stage of the compressor can mount to the core casing 46 in a circumferential arrangement.

Complementary to the rotor portion, the stationary portions of the engine 10, such as the static vanes 60, 62, 72, 74 among the compressor and turbine section 22, 32 are also referred to individually or collectively as a stator 63. As such, the stator 63 can refer to the combination of non-rotating elements throughout the engine 10.

In operation, the airflow exiting the fan section 18 splits such that a portion of the airflow is channeled into the LP compressor 24, which then supplies pressurized air 76 to the HP compressor 26, which further pressurizes the air. The pressurized air 76 from the HP compressor 26 mixes with fuel in the combustor 30 where the fuel combusts, thereby generating combustion gases. The HP turbine 34 extracts some work from these gases, which drives the HP compressor 26. The HP turbine 34 discharges the combustion gases into the LP turbine 36, which extracts additional work to drive the LP compressor 24, and the exhaust gas is ultimately discharged from the engine 10 via the exhaust section 38. The driving of the LP turbine 36 drives the LP spool 50 to rotate the fan 20 and the LP compressor 24.

A portion of the pressurized airflow 76 can be drawn from the compressor section 22 as bleed air 77. The bleed air 77 can be drawn from the pressurized airflow 76 and provided to engine components requiring cooling. The temperature of pressurized airflow 76 entering the combustor 30 is significantly increased. As such, cooling provided by the bleed air 77 is necessary for operating of such engine components in the heightened temperature environments.

A remaining portion of the airflow 78 bypasses the LP compressor 24 and engine core 44 and exits the engine 10 through a stationary vane row, and more particularly an outlet guide vane assembly 80, comprising a plurality of airfoil guide vanes 82, at the fan exhaust side 84. More specifically, a circumferential row of radially extending airfoil guide vanes 82 are utilized adjacent the fan section 18 to exert some directional control of the airflow 78.

Some of the air supplied by the fan 20 can bypass the engine core 44 and be used for cooling of portions, especially hot portions, of the engine 10, and/or used to cool or power other aspects of the aircraft. In the context of a turbine engine, the hot portions of the engine are normally downstream of the combustor 30, especially the turbine section 32, with the HP turbine 34 being the hottest portion as it is directly downstream of the combustion section 28. Other sources of cooling fluid can be, but are not limited to, fluid discharged from the LP compressor 24 or the HP compressor 26.

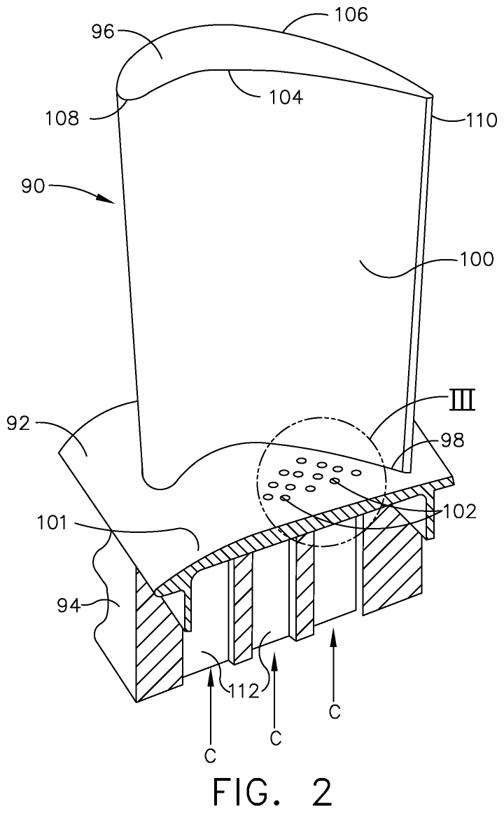

FIG. 2 is a perspective view of an example of an engine component illustrated as an airfoil 90, a platform 92, and a dovetail 94, which can be a rotating blade 68, as shown in FIG. 1. Alternatively, it is contemplated that the airfoil 90 can be a stationary vane, such as the vane 72 of FIG. 1, while any suitable engine component is contemplated. The airfoil 90 includes a tip 96 and a root 98, defining a span-wise direction there between. Additionally, the airfoil 90 includes a wall 100. A pressure side 104 and a suction side 106 are defined by the airfoil shape of the wall 100.

The airfoil 90 mounts to the platform 92 at the root 98. The platform 92 is shown in section, but can be formed as an annular band for mounting a plurality of airfoils 90. The airfoil 90 can fasten to the platform 92, such as welding or mechanical fastening, or can be integral with the platform 92 in non-limiting examples. According to an aspect of the disclosure herein, at least one cooling hole 102 is formed in a wall 101 of the platform 92. The at least one cooling hole 102 can be multiple cooling holes 102 as illustrated, and, by way of non-limiting example, can be located in the platform 92 on the pressure side 104 of the airfoil 90. The airfoil 90 further includes a leading edge 108 and a trailing edge 110, defining a chord-wise direction.

The dovetail 94 couples to the platform 92 opposite of the airfoil 90, and can be configured to mount to the disk 71, or rotor 51 of the engine 10 (FIG. 1), for example. In one alternative example, the platform 92 can be formed as part of the dovetail 94. The dovetail 94 can include one or more inlet passages 112, illustrated as three inlet passages 112. It is contemplated that the inlet passages 112 are fluidly coupled to the cooling holes 102 to provide a cooling fluid flow (C) for cooling the platform 92. In another non-limiting example, the inlet passages 112 can provide the cooling fluid flow (C) to an interior of the airfoil 90 for cooling of the airfoil 90. It should be appreciated that the dovetail 94 is shown in cross-section, such that the inlet passages 112 are housed within the body of the dovetail 94.

It should be understood that while the description herein is related to an airfoil, it can have equal applicability in other engine components requiring cooling via cooling holes such as film cooling. One or more of the engine components of the engine 10 includes a film-cooled substrate, or wall, in which a film cooling hole, or hole, of the disclosure further herein may be provided. Some non-limiting examples of the engine component having a wall can include blades, vanes or nozzles, a combustor deflector, combustor liner, or a shroud assembly. Other non-limiting examples where film cooling is used include turbine transition ducts and exhaust nozzles.

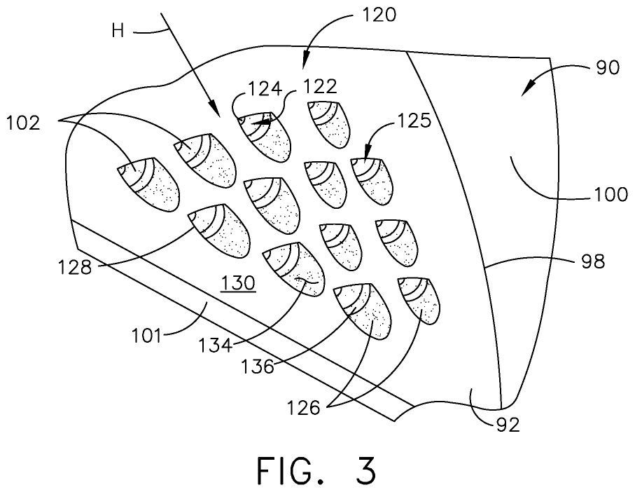

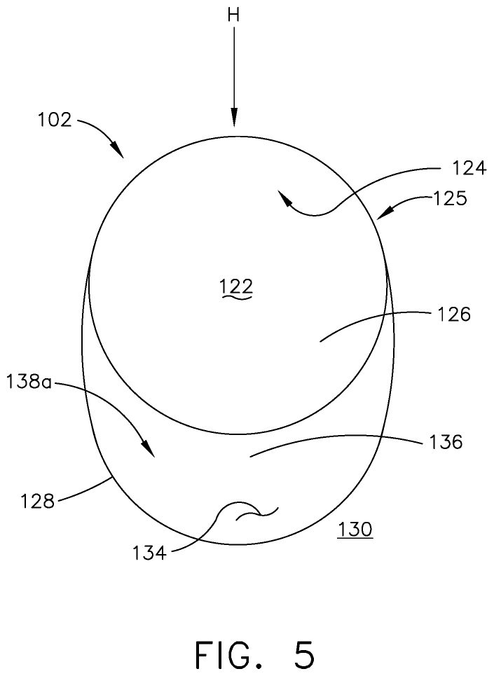

FIG. 3 is an enlarged portion III taken from FIG. 2 of a group 120 of cooling holes 102 before a coating 140 (FIG. 5) is applied. While any number of cooling holes 102 can form the group 120, thirteen cooling holes 102 are shown for illustrative purposes only and are not meant to be limiting. Each of the cooling holes 102 is defined by a connecting passage 122 extending from an inlet 124 to an outlet 125 and terminating in a pocket 126 formed within the wall 101 of the platform 92. The pocket 126 defines an opening 128 in the same plane as a heated surface 130 of the platform 92. The heated surface 130 faces a hot gas fluid flow (H) during operation.

The pocket 126 is fluidly coupled to the connecting passage and can include a sidewall 134 extending into the heated surface 130 of the platform 92 to define at least a portion of the pocket 126. The sidewall 134 is located on a downstream side of the outlet 125 with respect to the hot gas fluid flow (H). A lip 136 can be formed where the sidewall 134 meets the connecting passage 122. The lip 136 can be a conical or variable curvature surface. It is further contemplated that the lip 136 is a ridge or planar portion located at a depth (D) at which the pocket 126 extends into the wall 101 of the platform 92. It should be understood that the lip 136 can be any geometric shape formed at the depth (D). The depth (D) is determined with respect to the formation of a shelf 118 located on an upstream side of the outlet 125 at the heated surface 130. The shelf 118 can shield or cover the connecting passage 122. The lip 136 is located downstream of an upstream side of the outlet, and more particularly the shelf 118. In this manner, the shelf 118 overhangs the connecting passage 122, while leaving the lip 136 uncovered.

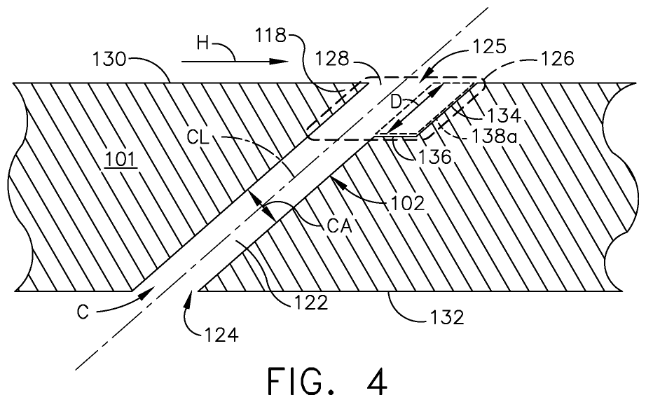

FIG. 4 is a schematic, sectional view of one of the cooling holes 102 extending through the wall 101 of the platform 92. The wall 101 of the platform 92 includes the heated surface 130 facing the hot gas fluid flow (H) and a cooled surface 132 facing the cooling fluid (C). It should be understood that the wall 101 of the platform can be any substrate within the engine 10 including but not limited to the airfoil wall 100, a tip wall, or a combustion liner wall. Materials used to form the substrate include, but are not limited to, steel, refractory metals such as titanium, or superalloys based on nickel, cobalt, or iron, and ceramic matrix composites. The superalloys can include those in equiaxed, directionally solidified, and crystal structures. The substrate can be formed by, in non-limiting examples, 3D printing, investment casting, or stamping.

It is noted that although the wall 101 of the platform 92 is shown as being generally planar in FIG. 4, it should be understood that the wall 101 of the platform 92 can be curved for many engine components. Whether the wall 101 of the platform 92 is planar or curved local to the cooling hole 102, the hot and cooled surfaces 130, 132 can be parallel, especially on a local basis, to each other as shown herein, or can lie in non-parallel planes.

The cooling hole 102 provides fluid communication between the cooling fluid (C) supply and an exterior of the platform 92. During operation, the cooling fluid flow (C) can be supplied via the inlet passages 112 and exhausts from the cooling hole 102 as a thin layer or film of cool air along the heated surface 130. While only one cooling hole 102 is shown in FIG. 3, it is understood that the cross-sectional view can represent any one of the cooling holes 102 within the group 120 shown in FIG. 2.

It can more clearly be seen that the inlet 124 for the cooling hole 102 is provided on the cooled surface 132 and the outlet 125 is provided on the heated surface 130. The connecting passage 122 extends between the inlet 124 and the outlet 125 and can at least partially define the cooling hole 102 through which the cooling fluid (C) can flow. The connecting passage 122 can have a constant cross-sectional area (CA) extending from the inlet 124 towards the outlet 125 and maintained for at least a portion of the connecting passage 122. A passage centerline (CL) defined by the connecting passage 122 can extend through a geometric center of the constant cross-sectional area (CA). The passage centerline (CL) extends from the outlet 125 with a component that is oriented in a downstream direction relative to the hot fluid flow (H) at the outlet 125, which helps the emitted air remain attached or adjacent the hot surface 130 in the form of a film during operation. If the cooling hole 102 was oriented upstream at the outlet 125, the emitted cooling flow would be against the hot fluid flow (H) and would more likely separate from the heated surface 130 and not form a film.

The pocket 126 can be formed at or near the outlet 125 and defines at least a portion of the connecting passage 122. A pocket portion 138a proximate the connecting passage 122 can extend to a depth (D) to form the lip 136 and the sidewall 134. The sidewall 134 extends laterally from, or substantially parallel to, the passage centerline (CL) and is spaced from the passage centerline (CL) of the connecting passage 122. It is contemplated that the sidewall 134 and passage centerline (CL) can be parallel within +/−5° of each other.

Turning to FIG. 5, a top view of the cooling hole 102 is illustrated. In one non-limiting example, the cooling hole 102 can be a drilled cooling hole. To form the laterally spaced sidewall 134 a drill can be angled in substantially the same orientation when forming both the connecting passage 122 and the pocket portion 138a proximate the connecting passage 122 defining the sidewall 134. It is contemplated that the pocket 126 is drilled to the depth (D) and then the connecting passage 122 is drilled, or vice versa. It is contemplated that the same drill bit is used such that the cooling hole has a circular cross-sectional area and the pocket portion 138a has a semi-circular cross-sectional area. It is further contemplated that the pocket portion 138a varies in downstream width and that different sized drill bits are utilized to form the pocket 126 and the connecting passage 122.

It is further contemplated that the connecting passage 122 and pocket 126 are additively manufactured, by way of non-limiting example formed by 3D printing or investment casting. Formation of the connecting passage 122 and pocket 126 are described for illustrative purposes only and are not limited to the methods described herein.

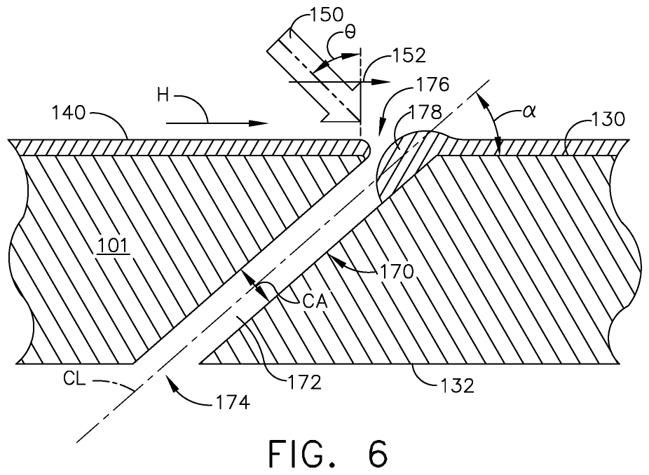

Turning to FIG. 6, a straight drilled cooling hole 170 is illustrated. A connecting passage 172 extending between an inlet 174 along the cooled surface 132 and an outlet 176 along the heated surface 130 is drilled through, by way of non-limiting example, the platform wall 101. Before operation, a coating 140, by way of non-limiting example a thermal barrier coating (TBC), can be applied to the heated surface 130. The coating 140 can be applied at an application angle θ measured from a normal line, with respect to the heated surface 130, to a centerline of a thick arrow, or an application line 150 representing a sprayer used to apply the coating 140. In one aspect of the disclosure herein an angle α formed between a centerline (CL) of the straight drilled cooling hole 170 and the heated surface 130 can have the same magnitude as the application angle θ. In other words the application line 150 and the centerline (CL) of the straight drilled cooling hole 170 are perpendicular to each other forming an angle of intersection β. Angles θ and α do not need to be equal to each other and can have values such that the angle if intersection β is between 70 and 110 degrees, or between 60 and 120 degrees. The angle of intersection β can vary while still enabling a direct application of the coating 140. In one aspect of the disclosure herein, the coating 140 is applied at the application angle θ while moving in a downstream direction, illustrated by arrow 152, with respect to the hot gas fluid flow (H). It is contemplated that the application angle θ is greater than 30°, and in an aspect of the disclosure herein the angle θ is 45°.

During application of the coating 140, the coating 140 can form a blocking portion 178, wherein some or all of the outlet 176 becomes blocked when the coating 140 partially fills the straight drilled cooling hole 170. When spraying in this manner at the application angle θ, most of the coating 140 that partially fills/blocks the hole comes from spraying directly into the hole 170 and run back of the coating 140. The pocket 126 as described herein is located at this position to catch the spray and the run back.

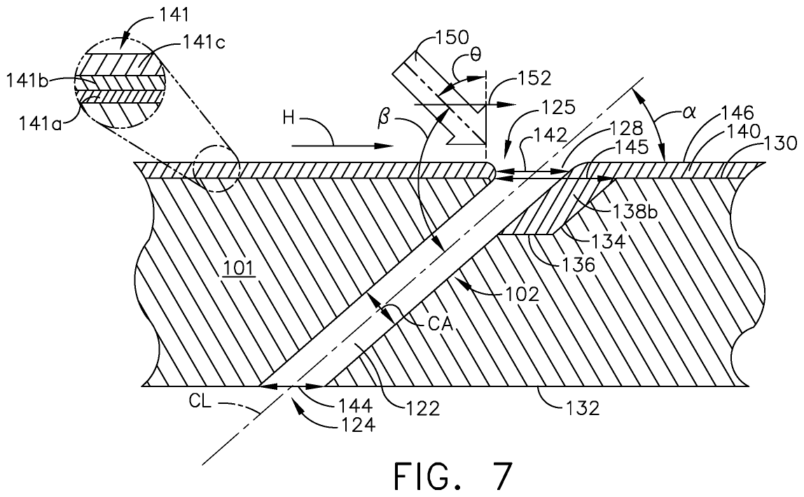

Turning to FIG. 7, the cooling hole 102 with a pocket 126 formed as illustrated in FIG. 4 is shown after the coating 140 has been applied in the manner previously described herein. The coating 140 can be a TBC, by way of non-limiting example a thermally insulated material in the form of multiple layers 141. In a non-limiting example the layers can include a metallic bond coat 141a, thermally grown oxide 141b, and a ceramic topcoat 141c.

A method for forming the cooling hole 102 with a predetermined outlet dimension 142 can include forming the cooling hole 102 such that the inlet 124 is located on a first surface, by way of non-limiting example the cooled surface 132 described herein, and defines an inlet dimension 144. The method includes forming the connecting passage 122 to connect the inlet 124 to the outlet 125, by way of non-limiting example using methods already described herein. The outlet 125 is formed with a predetermined outlet dimension 142 and is located on a second surface, by way of non-limiting example a top surface 146 of the coating 140.

The method also includes forming the pocket 126 in a wall, by way of non-limiting example the wall 101 of the platform 92 as described herein, with the opening 128 having an opening dimension 145 that is larger than the predetermined outlet dimension 142. In one aspect of the disclosure, the inlet dimension 144, opening dimension 145 and the predetermined outlet dimension 142 are cross-sectional areas. It is contemplated that the cross-sectional area of the opening dimension 145 is larger than the predetermined outlet dimension, and in at least one aspect of the disclosure herein is twice as large as the cross-sectional area of the predetermined outlet dimension 142. It is further contemplated that the dimensions can be any measurable dimensions, in other non-limiting examples a diameter, a length, or a width.

Furthermore, the method includes applying the coating 140 along the heated surface 130 such that the coating 140 fills in the pocket portion 138a (FIG. 4). In one aspect of the disclosure herein, applying the coating 140 includes vaporizing the coating, where the coating falls like snow to create an even coat-down within the pocket portion 138a. The sidewall 134 and pocket portion 138a shape account for this process. Upon completion of the application the pocket portion 138a now defines a filled portion 138b leaving the outlet 125 with the predetermined outlet dimension 142. In this manner the connecting passage 122 is defined at least in part by the material from which the wall 101 of the platform 92 is formed, by way of non-limiting example a metal, and in part by the coating 140.

In one aspect of the disclosure herein, the inlet dimension 144 and the predetermined outlet dimension 142 are the same. By “the same” they are formed at opposing ends of the connecting passage 122 and the connecting passage 122 maintains a constant cross-sectional area (CA) from the inlet 124 to the outlet 125 after the coating 140 is applied. It is contemplated that the inlet dimension 144 and the outlet dimension 142 are similar in size but can vary with respect to each other by +/−5%.

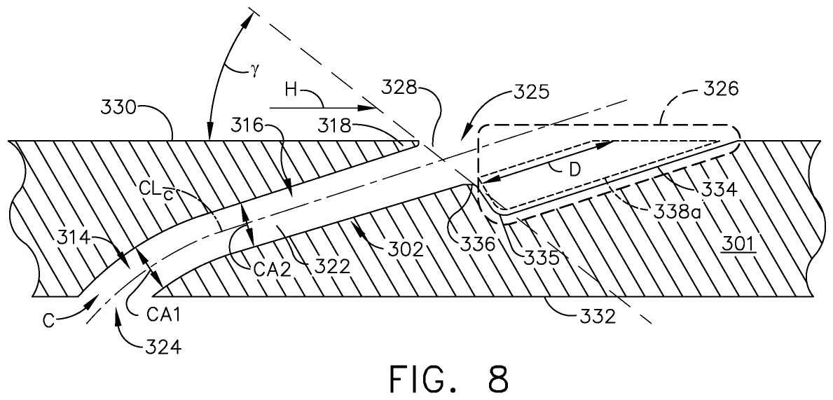

Turning to FIG. 8, a cooling hole 302 is illustrated in cross-section according to another aspect of the disclosure herein. The cooling hole 302 is similar to the cooling hole 102 therefore, like parts will be identified with like numbers increased by 200, with it being understood that the description of the like parts of the cooling hole 102 applies to the cooling hole 302 unless otherwise noted.

In an aspect of the disclosure herein, the cooling hole 302 can be defined at least in part by a connecting passage 322 extending between an inlet 324 on a cooled surface 332 to an outlet 325 on a heated surface 330. The connecting passage 322 can define a curvilinear centerline (CLc). A shelf 318 located on the upstream side of the cooling hole 302 with respect to the hot gas fluid flow (H) can define at least a portion of the outlet 325. The shelf 318 can be formed to line up with some angle α with respect to the heated surface 330. In one non-limiting example the angle γ is 45°, but can be any angle suitable for coating the heated surface 330 as described herein.

A pocket 326 can be formed at or near the outlet 325 and defines at least a portion of the connecting passage 322. In one non-limiting example, the pocket 326 can also be formed, at least in part, by a drill. A pocket portion 338a proximate the connecting passage 322 can be drilled to a depth (D) to form a trench portion 335 between a lip 336 and sidewall 334. The sidewall 334 extends laterally from, or substantially parallel to, the curvilinear centerline (CLc) at the outlet 325 and is spaced from the curvilinear centerline (CLc) of the connecting passage 322. It is contemplated that the sidewall 334 and curvilinear centerline (CLc) are parallel within +/−5° of each other.

In one aspect of the disclosure herein the connecting passage 322 can be formed by additive manufacturing while the pocket portion 338a is drilled. It is further contemplated that the connecting passage 322 is a straight connecting passage much like the connecting passage 122 already described herein and the pocket portion 338a includes the trench portion 335. Furthermore, the entire cooling hole 302 can be additively manufactured, by way of non-limiting example formed by 3D printing. It is further contemplated that the entire cooling hole 302 is formed by investment casting. Formation of the connecting passage 322 and pocket 326 are described for illustrative purposes only and are not limited to the methods described herein.

In one exemplary aspect of the disclosure herein, the connecting passage 322 can further include a metering section 314 having a circular cross section, though it could have any cross-sectional shape. The metering section 314 can be provided at or near the inlet 324, and extend along the connecting passage while maintaining a constant cross-sectional area (CA1). The metering section 314 defines the smallest, or minimum cross-sectional area (CA1) of the connecting passage 322. It is further contemplated that the metering section 314 defines the inlet 324 without extending into the connecting passage 322 at all. It is also contemplated that the metering section 314 has no length and is any other location where the cross-sectional area (CA1) is the smallest within the connecting passage 322.

In another aspect of the disclosure herein, the connecting passage 322 can define an increasing cross-sectional area (CA2) where at least a portion of the increasing cross-sectional area (CA2) defines a diffusing section 316 having a maximum cross-sectional area of the passage. In some implementations the cross-sectional area (CA) is continuously increasing as illustrated. In yet another implementation the cross-sectional area (CA) can vary along the extent of the connecting passage 322 to define multiple metering and diffusing sections.

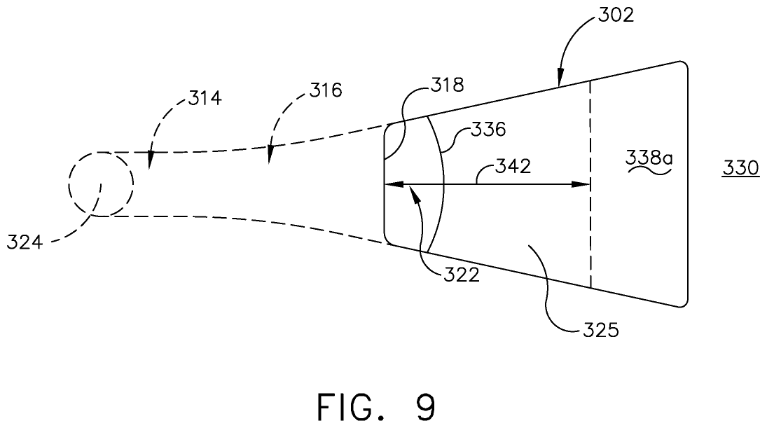

FIG. 9 is a top down view of the cooling hole 302. In an aspect of the disclosure herein a ‘straight’ shelf 318 enables an even coverage of the connecting passage 322 to ensure a coating 340 falls in the pocket portion 338a. While a curved shelf 318 is possible, it may allow the coating 340 to fall in undesirable areas of the cooling hole 302. By way of non-limiting example, the shelf 318 can also be angled, curved, or otherwise adjusted to fit a given design application with respect to the coating application. By way of non-limiting example, if TBC was applied at a compound angle, the shelf could be angled to ensure even coat down.

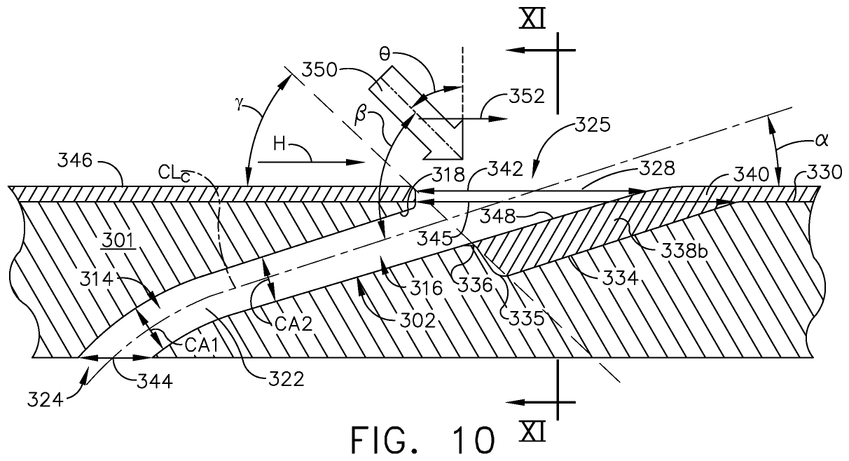

Turning to FIG. 10, the coating 340 can be applied to the heated surface 330. When applying the coating 340, in one aspect of the disclosure herein a plasma method, similar to spray paint, can be used which can create an un-even coat down. In this case the trench portion 335 is included in the pocket portion 338a (FIG. 6) of the cooling hole 302 to account for this process by catching the run down and preventing the coating 340 from moving into the connecting passage 322 upstream of the outlet 325 with respect to the cooling fluid flow (C). The caught coating defines the filled portion 338b.

The shelf 318 as described herein functions to block the applied coating 340 during application from the connecting passage 322, while allowing, by way of non-limiting example the TBC to hit the trench portion 335 for any angle γ. Therefore the shape of the shelf 318 can be blunt and square as illustrated, or any shape best suited for different design applications. As described herein, γ is 45 degrees, as is the application angle θ so that coating 340 would fall on top of the shelf 318 for part of the cooling hole 302, but fill in the trench portion 335 for the diffusing section 316 of the cooling hole 302.

In an aspect of the disclosure herein, the diffusing section 316 can be defined, at least in part, by the coating 340 forming the filled portion 338b. In an aspect of the disclosure herein the portion of the diffusing section 316 defined by the coating 340 also defines at least a portion of the outlet 325.

The metering section 314 is for metering of the mass flow rate of the cooling fluid flow (C). The diffusing section 316 enables an expansion of the cooling fluid (C) to form a wider and slower cooling film on the coating 340 applied along the heated surface 330. The diffusing section 316 can be in serial flow communication with the metering section 314. It is alternatively contemplated that the cooling hole 302 have a minimal or no metering section 314, or that the diffusing section 316 extends along the entirety of the cooling hole 302.

The method as described herein can further include forming the cooling hole 302 with a first outlet dimension 344 that is smaller than a predetermined outlet dimension 342. The method can also include forming the predetermined outlet dimension 342 to define at least a portion of the diffusing section 316 at the outlet 325.

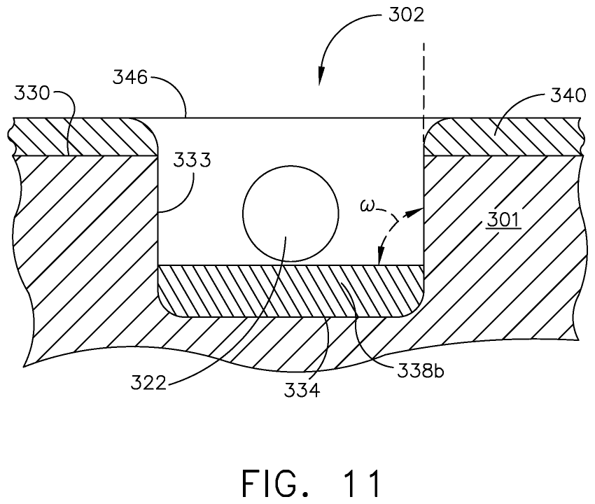

FIG. 11 is a cross-sectional view of cooling hole 302 taken along line XI-XI of FIG. 10. It can be seen that when the coating 340 is applied, application is on the heated surface 330 and within pocket portion 338a that becomes filled portion 338b. Coating 340 need not necessarily coat any perpendicular sidewalls 333 of the cooling hole 302 which are oriented at an angle ω, which can be 90 degrees. In an aspect of the disclosure herein, the angle ω can vary between 70 and 110 degrees such that the perpendicular sidewalls 333 are nearly perpendicular to the sidewall 334.

In still another aspect of the disclosure herein illustrated in FIG. 11, cooling holes 102a with a cross-sectional area (CAa), illustrated in a bubble A, can be formed in a platform 92a. Multiple connecting passages 122a can be, by way of non-limiting example, drilled to form a group 120a of nine cooling holes 102a.

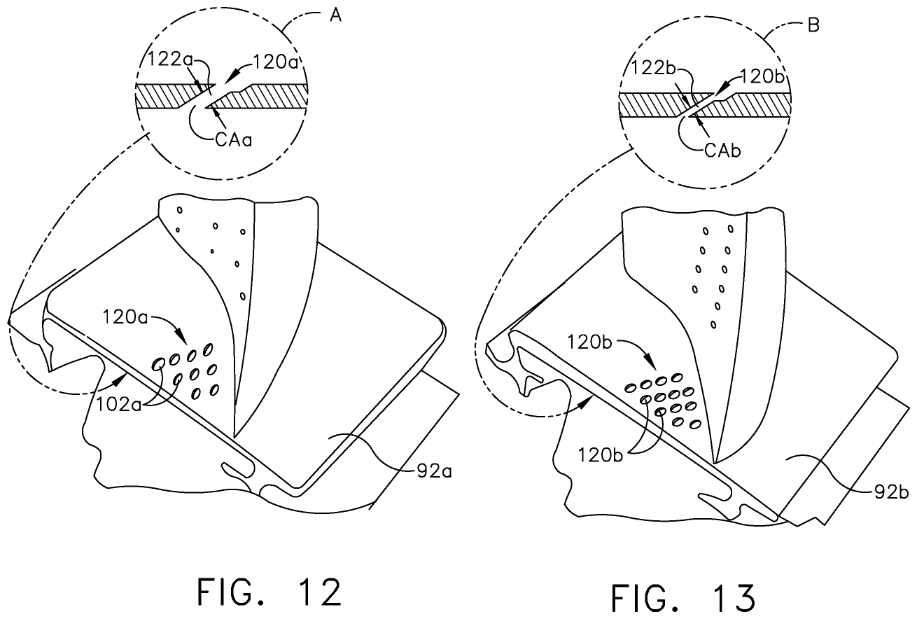

Turning to FIG. 12, comparatively, cooling holes 102b with a cross-sectional area (CAb), illustrated in bubble B, are smaller than the cross-sectional area (CAa) of the cooling holes 102a. Multiple connecting passages 122b can form group 120b of thirteen cooling holes 102b. The group 120b of cooling holes 102b is greater in number of cooling holes 102b with respect to the group 120a because the smaller cross-sectional area (CAb) of the connecting passage 122b allows for a maximum use of wall space within platform 92b. This enables maximum film cooling along the surface of the platform 92b as well.

Additional benefits associated with the disclosure as described herein relate to cooling hole shapes formed to account for later application of a thermal barrier coating. This disclosure can be applied to most applications where hot section hardware makes use of thermal barrier coating. The advantages are primarily related to cost and durability. Cost can be an advantage in the sense that traditionally, metal is sprayed with TBC, then drilled for cooling holes (via EDM or Laser or other). This way, metal is formed with holes already in place, be it by additive manufacturing or drilling, and then spray is applied thus reducing manufacturing requirements and cost. Durability is an advantage due to the counter coat down geometry to improve the cooling hole exit and diffuser shape for enhanced film cooling.

Turbine cooling is important in next generation architecture which includes ever increasing temperatures. Current cooling technology needs to expand to the continued increase in core temperature of the engine that comes with more efficient engine design. Optimizing cooling at the surface of engine components by designing cooling hole geometry with later thermal barrier coating application in mind improves the entire engine performance.

It should be appreciated that application of the disclosed design is not limited to turbine engines with fan and booster sections, but is applicable to turbojets and turbo engines as well.

This written description uses examples to illustrate the disclosure as discussed herein, including the best mode, and also to enable any person skilled in the art to practice the disclosure as discussed herein, including making and using any devices or systems and performing any incorporated methods. The patentable scope of the disclosure as discussed herein is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A component for a turbine engine which generates a hot gas fluid flow, and provides a cooling fluid flow, comprising:
a wall separating the hot gas fluid flow from the cooling fluid flow and having a heated surface along which the hot gas fluid flow flows and a cooled surface facing the cooling fluid flow;
at least one cooling hole comprising at least one inlet at the cooled surface and at least one outlet extending between an upstream side and a downstream side with respect to the hot gas fluid flow at the heated surface, at least one connecting passage extending between the at least one inlet and the at least one outlet to define a passage centerline;
at least one pocket opening onto the heated surface, opening into the connecting passage below the heated surface, having a sidewall extending laterally to and spaced from the passage centerline, and having a lip located downstream of the upstream side of the outlet; and
a coating provided on the heated surface, surrounding the at least one outlet, and filling a portion of the pocket to define a filled portion which defines at least a portion of the connecting passage.

2. The component of claim 1 wherein the sidewall is located on a downstream side of the outlet with respect to the hot gas fluid flow and a shelf is located on the upstream side of the outlet.

3. The component of claim 2 wherein the lip extends into the at least one connecting passage away from the sidewall and is formed at a location relative to the shelf where the at least one connecting passage is fluidly connected to the at least one pocket and the shelf overhangs the connecting passage while leaving the lip uncovered.

4. The component of claim 3 wherein the coating is applied in an upstream to downstream direction with respect to the hot gas fluid flow.

5. The component of claim 4 wherein the coating is applied at an application angle greater than or equal to 30 degrees from a normal line with respect to the heated surface.

6. The component of claim 5 wherein a line drawn along the application angle forms an angle of intersection with the sidewall that is between 70 and 110 degrees.

7. The component of claim 6 wherein the line drawn along the application angle is perpendicular to the sidewall.

8. The component of claim 7 wherein the at least one pocket further comprises a trench portion located between the lip and the sidewall.

9. The component of claim 1 wherein the at least one pocket defines a first cross-sectional area at the heated surface greater than a second cross-sectional area of the outlet at the heated surface.

10. The component of claim 9 wherein the first cross-sectional area is twice as large as the second cross-sectional area.

11. The component of claim 9 wherein a cross-sectional area of the connecting passage varies along the extent of the connecting passage.

12. The component of claim 9 wherein the connecting passage further defines a diffusing section having a maximum cross-sectional area and at least a portion of the diffusing section is defined by the filled portion.

13. The component of claim 1 wherein the component is an airfoil.

14. The component of claim 13 wherein the wall forms a platform for the airfoil.

15. The component of claim 1 wherein the at least one cooling hole is a drilled cooling hole.

16. The component of claim 1 wherein the at least one cooling hole is formed from additive manufacturing or casting.

17. The component of claim 1 wherein the coating is a thermal barrier coating.

18. The component of claim 17 wherein the thermal barrier coating is comprises multiple layers.

19. A method for forming a cooling hole with a predetermined outlet dimension in a wall of an engine component for a turbine engine, with the wall defining first and second surfaces separating a hot gas fluid flow from a cooling fluid flow, the method comprising:
forming the cooling hole in the wall such that the cooling hole has an inlet on the first surface with an inlet dimension, an outlet extending between an upstream side and a downstream side with respect to the hot gas fluid flow and located on the second surface, and a connecting passage connecting the inlet and the outlet;
forming a pocket in the wall downstream of the upstream side of the outlet and fluidly coupled to the connecting passage to define an opening with a dimension larger than the predetermined outlet dimension; and
applying a coating to the engine component such that the coating fills in at least a portion of the pocket while leaving the outlet with the predetermined outlet dimension.

20. The method of claim 19 wherein the predetermined outlet dimension and the inlet dimension are the same.

21. The method of claim 19 wherein the inlet dimension is smaller than the predetermined outlet dimension.

22. The method of claim 21 wherein the predetermined outlet dimension defines at least a portion of a diffusing section at the outlet.

23. The method of claim 19 further comprising applying the coating with a sprayer oriented along an application line 30 degrees or more from a line normal to the second surface.

24. The method of claim 23 further comprising forming the pocket with a sidewall that forms an angle of between 70 and 110 degrees with the application line.

25. The method of claim 24 wherein the application line is perpendicular to the sidewall.
